(19) United States
(12) Patent Application Publication
(10) Pub. No.: US 2020/0160469 A1
(43) Pub. Date: May 21, 2020

(54) Electronic Media Consumer Debt Negotiation System and Method

(71) Applicant: Stephanie Hoskins, Baton Rouge, LA (US)

(72) Inventor: Stephanie Hoskins, Baton Rouge, LA (US)

(21) Appl. No.: 16/667,751

(22) Filed: Oct. 29, 2019

Related U.S. Application Data
(60) Provisional application No. 62/752,728, filed on Oct. 30, 2018.

(51) Int. Cl. G06Q 50/18; G06Q 40/02; G06Q 20/14; G06Q 10/10; G06Q 20/10

(52) U.S. Cl. CPC G06Q 50/188; G06Q 40/02; G06Q 20/14; H04L 67/10; G06Q 20/102; G06Q 20/108; G06Q 10/10

(57) ABSTRACT

A Debt Negotiation System and Method for direct debt settlement process between a debtor and a debt owner is described. The proposed system and method resolve the handling of the asymmetrical information dilemma plaguing debt negotiations by validating and guaranteeing the debtor and debt owner's positions and promises during the negotiation. The proposed system and method utilize electronic media allowing for immediate money transfers to settle the delinquent accounts, avoiding lengthy and wasteful legal proceedings and collection efforts.

### CROSS-REFERENCE TO RELATED APPLICATIONS

This application is based on and claims benefit to U.S. provisional application 62/752,728 filed on Oct. 30, 2018.

### BACKGROUND OF THE INVENTION AND PRIOR ART

The present system and method relate to electronic media technologies for the process of the debt collection. Debt collection is an imperative part of any business relationship. Particularly, the present invention could be used to streamline the process of the debt negotiation and debt settlement, leading to a mutually agreeable resolution.

Electronic media is defined as media that uses electronics or electromechanical energy for the end-user (audience) to access the content. Electronic media differs from a static media (usually print media). Modern day static media is often created electronically, but electronics are not required for the end-user to reach its content in the printed form. The main electronic media sources familiar to the general public are online content, video recordings, audio recordings, multimedia presentations, slide presentations, CD-ROM, and online content. Most new electronic media are in the form of digital media. Digital media are any media that are encoded in a machine-readable format. New electronic media usually refers to websites, video games, and social media, where content is available on-demand through the Internet, accessible on any digital device, usually containing interactive user feedback and creative participation. Electronic media may be in either analogue electronics data or digital electronic data format. Any equipment used in the electronic communication process (e.g. desktop computer, laptop, handheld device, telephone, television, radio, game console, etc.) may also be considered electronic media.

In a world of business, be it a trade, service, education, or any relationship that involves a payment, parties regularly deal with the debt negotiation and collection. Debt arises any time consumer is unable to make the full payment for either a merchandize or a service. Consumer and seller enter into a payment agreement, at which point consumer becomes a debtor, and seller becomes a debt collector. Problems with the payment agreement ensue the moment the payment becomes delinquent. At that point, debt collector has to decide whether to expend resources and to initiate a legal battle with the debt collection through the court system, or to attempt negotiating with the debtor in hopes to recover at least part of the debt, avoiding the legal expenses.

In many instances legal battles produce no result. Going through the collection process in the court system is cumbersome and expensive. The process involves filing the claim with the court, serving the debtor with the notice, appearing at least two hearings in order to obtain a judgment against the debtor, and then dealing with the step of collecting on the judgment. Debtors often refuse to pay on the judgment, prompting debt collectors to continue with the litigation, entering in the proceeding supplemental stage with the goal to garnish debtor's accounts or collect some of the debtor's assets. Proceeding supplemental litigation usually involves another filing with the court, serving the debtor with discovery requests, attempting to gain information on debtor's bank accounts and assets, and finally, attending at least one hearing to secure a garnishment order. Garnishments are strictly regulated and could spread over a long period of time. It was estimated that court-ordered garnishments typically result in only 38% recovery of the debt. And of course, there is always a possibility of either discovering that debtor is “judgment-proof”, getting “surprised” with the debtor's filing for the bankruptcy protection, or getting the claim for the debt dismissed due to the improper procedural handling of the claim.

Therefore, the debt collection is a tricky process, involving the steps of carefully investigating the ability of the debtor to satisfy the debt, testing debtor's ability to satisfy at least some portion of the debt, and triggering the debtor's desire and understanding to agree to any terms to satisfy the portion of the debt.

Prior to utilizing the electronic media, debt collection involved simple oral communications between the debt collector and the debtor, with additional exchange of the printed media, i.e. bank account printouts, promissory notes, payment agreements, etc. Telephonic communications made the process a little faster. Utilizing electronic media through computers and computer networks brought the process to a different level in terms of efficiency of communication and document preparations. Nonetheless, the sensitive steps of the debt negotiation are still not addressed. Current methods to negotiate with individual consumers for each individual bad debt or delinquent account are not efficient. There is a certain disconnect in the shared information within the most commonly utilized existing negotiation methods. In order to settle, the parties to the debt negotiation should develop some level of trust. Specifically, the individual debtor generally knows ahead of time the maximum amount of money they can pay towards the debt while the debt collector is uncertain as to how far they may be able to push the debtor, without causing debtor quitting any further negotiations. Debt collectors often offer a discount on the debt in order to settle the account, however debtors regularly do not trust the debt collectors to settle the account once they agree to make a payment. Due to current practices, making a payment on the outstanding debt could trigger the renewal of the debt account. Such asymmetrical information handling dilemma was never fully addressed in the prior art.

Electronic media generally can be greatly utilized to resolve complex business issues. Previously, a system was reported that involved soliciting communication from the debtor, while also obtaining debtor's financial information, analyzing such information, and suggesting the debt resolution based on the extracted information. Such system was debt-collector-centered, offering the debtor a plurality of claim settlement options determined specifically for the debtor, based on debtor's credit history extracted by the system through third-party sources. The previously described system solicited an input from the debtor only after the debt collector gained some knowledge of the debtor's prior history. The system does not give the debtor an equal standing in the negotiating process, risking that negotiations would break prior to debtor even entering his offer. Moreover, such system provides only a suggestion for the resolution, while the debt might remain unpaid.

Billions of dollars go uncollected every year. Huge efforts, thousands of workhours, and tremendous legal fees are expended in attempts to collect the bad debt. There is clearly a need in an improved system to offer the collection of bad debt.

The business process that is outlined here and made possible by the software application will enable consumers and firms to negotiate an individual bad debt or delinquent account efficiently and effectively. It solves the asymmetrical information handling problem by guaranteeing at least some funds and guaranteeing the promised debt forgiveness and a settlement.

### SUMMARY OF THE INVENTION

The suggested business method, also referred as “Consumer Debt Negotiation Tool” may be offered by the seller or service provider to a consumer as a computer or a telephone app at the beginning of the business deal or when the service being offered, so it does not come as a surprise at the point when the payment becomes delinquent. The business method of debt negotiations between a debt collector and a debtor, begins when an account becomes delinquent and the debtor owes an amount that is now considered overdue. Debt collector may offer the Consumer Debt Negotiation Tool as an option to Debtor to respond to the account being overdue, suggesting settling the account through the Consumer Debt Negotiation Tool in order to avoid any collection.

Once the Debtor gains an access to the Consumer Debt Negotiation Tool through the app, the system solicits the Debtor to make an anonymous offer to settle the overdue account. Such solicitation may introduce several options to the Debtor of either making a lump-sum payment or entering in multiple payments arrangement. While soliciting for an offer, the system requires the Debtor to provide an information of the Debtor's bank account to support the Debtor's offer. The system verifies through the bank the availability of the sum offered by the Debtor to the Debt collector. Upon the Debtor's placement of the offer, the offered sum is moved to an escrow account. After the sum is moved to an escrow account, the system signals to the Debt Collector the Debtor's willingness to negotiate the outstanding amount. At this step, the system has an option to keep the Debtor's identity anonymous, providing the Debt Collector only with the amount offered, with the amount of the outstanding debt, with the Debtor's credit history, and with the total amount owed by Debtor to other creditors.

The Debt Collector will have an option to either accept, decline or counter the offer. If the offer is accepted, the consumer will be issued a new statement and document confirming that the account has been settled and that no more debt is owed. As the funds from the escrow account get released to the Debt Collector, the system will produce a statement to Debtor reporting no balance owed. If the offer is declined by the Debt Collector, the account stays unchanged. If the Debt Collector counters the offer, the system will offer the Debtor an option to either accept or decline the counteroffer. If Debtor declines, no changes come to an account. If accepted, the escrow account automatically releases the sum to the Debt Collector, and the system generates a statement of the new balance still remaining on the Debtor's account, said balance being a difference between the counter-offer and the original Debtor's offer kept in the escrow account. The new terms of the account will be clearly stated in the newly generated account statement made available to both the Debtor and the Debt Collector. Prior to the escrow account's disbursement, the system provides an option for Debtor and Debt Collector to negotiate the terms of the remaining balance through either a payment plan or a lump-sum addition to the escrow.

The Debt Collector could customize the offered system for their specific operations, using the offered tool as their in-house service for all customers. Alternatively, the system could be offered as a cloud-based service through an app that could be accessed by either the computer or the smart phone through the web. The system links the Debtor Collector and their accounting system with the Debtor, the Debtor's bank account and the escrow account for the purposes of the debt negotiation.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a schematic representation of the process of debt negotiation from the prospective of steps taken by both the Debtor and the Debt owner;

FIG. 2 is a schematic representation of the algorithm for the software utilized by the Debt Negotiation System.

### DETAILED DESCRIPTION OF PREFERRED EMBODIMENTS

For the purposes of promoting and understanding the principles of the invention, reference will now be made to one or more illustrative embodiments illustrated in the drawings and specific language will be used to describe the same.

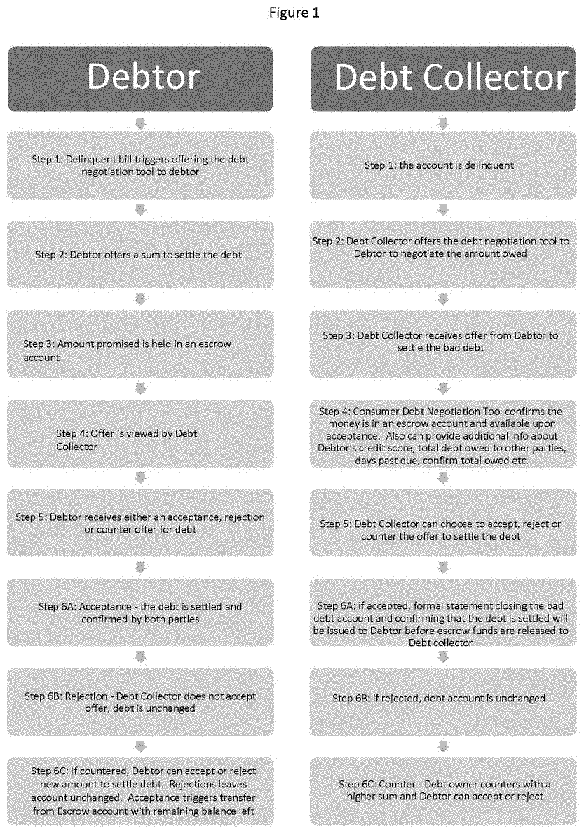

Referring to FIG. 1, a step-by-step process of the Debt Negotiation System process is depicted. The process could be followed in parallel, with each block on either side corresponding to actions by either the Debtor or the Debt Collector.

Step 1 corresponds to the system being initiated by the missed bill payment's deadline, when the account becomes delinquent. The delinquent bill triggers offering to the Debtor, initiated by the system, to participate in a debt negotiation process.

Step 2 provides opportunity to the Debt Collector to offer the debt negotiation tool to the Debtor with the invitation to negotiate the amount owed. At this point, the invitation to participate might include the explanation of the process, as well as the legal consequences, if Debtor ignores the offer. In response, the Debtor may offer a sum he believes he may afford to settle the amount of the debt.

Debtor's offering of the sum is depicted in Step 3, leading to the transfer of the offered amount from the Debtor's bank account to an escrow account. Simultaneously, the Debt owner receives a notification of the offer created by the Debtor. In Step 4, Debt owner is informed that Debtor's offer is placed in an escrow account and could be readily available if Debt owner chooses to accept the offer. Debtor is invited to check the offer, while the system provides the Debtor with additional information about the Debtor, like his credit score report, the total debt owned by the Debtor to other creditors, days past due on the payment, Debtor's employment information, etc.

Step 5 depicts the Debt Collector choosing to accept, reject or counter the offer to settle the debt, after learning additional information about the Debtor. As soon as the Debt Collector makes a choice, Debtor is informed whether his offer was accepted, rejected or countered. If the offer is accepted, the debt is settled, money is transferred from the escrow account to the Debt Collector's account, and the system generates a settlement statement informing all parties that the account is settled, and not debt is owed, according to the depicted step 6A. If the offer is rejected, the account remains unchanged, and the debt is still owed, according to the depiction of step 6B. Step 6C demonstrates the situation when the debt owner generates a counteroffer, asking for a larger amount in order to satisfy the debt owed. The Debt Collector's counteroffer triggers an invitation to Debtor to either accept or reject the new amount to settle the debt. If Debtor accepts the Debt Owner's counteroffer, the system transfers the balance kept in the escrow account to the Debt Owner's account, generating a statement of the amount still owed by the Debtor, totaling the difference between the Debt Owner's counteroffer and the balance on the escrow account. The system generates an offer to further negotiate the satisfaction of the remaining balance by either a lumpsum payment or by the payment plan. If Debtor rejects the counteroffer, the account remains unchanged and the debt remains owed by the Debtor remains unchanged.

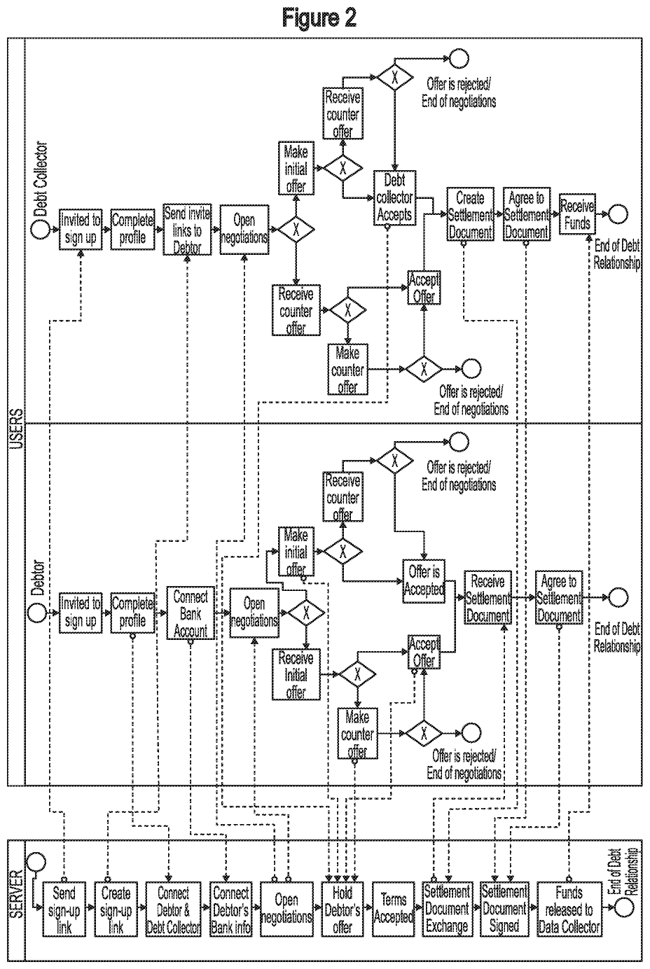

FIG. 2 provides a schematic representation of the algorithm utilized by the software to make the system operational.

While the invention has been illustrated and described in detail in the foregoing drawings and description, the same is to be considered as illustrative and not restrictive in character, it being understood that only illustrative embodiments thereof have been shown and described and that all changes and modifications that come within the sprit and scope of the invention as defined in the following claims are desired to be protected.

1. An Electronic Media Consumer Debt Negotiation System comprising:
A network of electronic media devices comprising:
Means for transmitting communications between a debt collector, a debtor, a debt collector's bank account, and a debtor's bank account, designed for the debt owner and the debtor to negotiate a debt;
a server equipped with a memory and configured to obtain all communications from the debt collector, the debtor, the debt collector's bank account, and the debtor's bank account, extract and analyze data in order to negotiate and settle the debt, obtain the debtor's financial and banking information from the debtor's bank account and from the web, and generate communications and commands to the debt collector, the debtor, the debt collector's bank account and the debtor's bank account;
wherein the network of electronic media devices is configured to initiate a communication to the debtor informing him about an unpaid debt as soon as the payment is delinquent, invite the debtor to enter an offer to pay the unpaid debt, invite the debtor to enter his banking information, analyze said banking information, move the balance of the offer from the debtor's bank account to an escrow account if the debtor makes the offer, invite the debt collector to either accept, reject or counter the debtor's offer, move the balance of the offer from the escrow account to the debt owner's bank account if the offer is accepted, generate a statement of the debt satisfaction to both the debtor and the debt owner, communicate the debt owner's counteroffer to the debtor if the counteroffer is made, generate a statement to both the debtor and the debt owner regarding an unpaid balance that would remain on the account if the counteroffer is accepted, inviting debtor to either accept or decline the counteroffer and generating the proposal on handling the unpaid balance, move the balance from the escrow account to the debt owner's bank account if the counteroffer is accepted, generate a statement to the debtor inviting debtor to schedule a payment on the remaining balance.

2. The network of electronic media devices of claim 1, wherein said means for transmitting communications is selected from the group consisting of computer, telephone, smart phone, laptop, videogame console and electronic server.

3. The network of electronic media devices of claim 1, wherein said server is cloud-based.

4. The network of electronic media devices of claim 1, wherein said server is configured to initiate communication to the debtor as soon as the debt payment deadline passes.

5. The network of electronic media devices of claim 1, wherein said server is configured to initiate communication to the debtor as soon as the debtor is offered to enter into a business relationship with the debt owner.

6. A method of negotiating debts, said method comprising the steps of:
Providing an Electronic Media Consumer Debt Negotiation System comprising:
Means for transmitting communications between a debt collector, a debtor, a debt collector's bank account, and a debtor's bank account, designed for the debt owner and the debtor to negotiate a debt;
a server equipped with a memory and configured to obtain all communications from the debt collector, the debtor, the debt collector's bank account, and the debtor's bank account, extract and analyze data in order to negotiate and settle the debt, obtain the debtor's financial and banking information from the debtor's bank account and from the web, and generate communications and commands to the debtor collector, the debtor, the debt collector's bank account and the debtor's bank account;
wherein the network of electronic media devices is configured to initiate a communication to the debtor informing him about an unpaid debt as soon as the payment is delinquent, invite the debtor to enter an offer to pay the unpaid debt, invite the debtor to enter his banking information, analyze said banking information, move the balance of the offer from the debtor's bank account to an escrow account if the debtor makes the offer, invite the debt collector to either accept, reject or counter the debtor's offer, move the balance of the offer from the escrow account to the debt owner's bank account if the offer is accepted, generate a statement of the debt satisfaction to both the debtor and the debt owner, communicate the debt owner's counteroffer to the debtor if the counteroffer is made, generate a statement to both the debtor and the debt owner regarding an unpaid balance that would remain on the account if the counteroffer is accepted, inviting debtor to either accept or decline the counteroffer and generating the proposal on handling the unpaid balance, move the balance from the escrow account to the debt owner's bank account if the counteroffer is accepted, generate a statement to the debtor inviting debtor to schedule a payment on the remaining balance;
Initiating a communication with the debtor as soon as the debt payment is delinquent, inviting the debtor to participate in a process of debt negotiation;
Soliciting the debtor's offer to make a payment on the delinquent debt and communicating said offer to the debt owner;
Transferring the balance of the debtor's offer from the debtor's bank account to an escrow account;
Inviting the debt owner to either accept, decline or counter the debtor's offer;
If the offer is accepted by the debt owner, releasing the money from the escrow account to the debt owner's bank account, and issuing a statement of the full debt satisfaction to both debtor and the debt owner;
If the debt owner issues a counteroffer, communicating said counteroffer to the debtor and offering the debtor to either accept or decline the counteroffer by the debt owner;
If the debtor accepts the counteroffer, releasing the money from the escrow account to the debt owner's bank account, and issuing a statement to both debtor and the debt owner with a remaining unpaid balance, offering to accept either a lumpsum payment or to enter into a payment plan to satisfy the remaining unpaid balance.
